(19) United States
(12) Patent Application Publication
(10) Pub. No.: US 2013/0062038 A1
(43) Pub. Date: Mar. 14, 2013

(54) Method and device for thawing frozen substances

(71) Applicant: Christopher E. Pearson, Glenview, IL (US)

(72) Inventor: Christopher E. Pearson, Glenview, IL (US)

(21) Appl. No.: 13/137,785

(22) Filed: Sep. 13, 2011

(51) Int. Cl. A23L 3/12

(52) U.S. Cl. 165/104.28

(57) ABSTRACT

A device for thawing a frozen substance includes a container defining a recess for accommodating a frozen substance therein. A fluid inlet line is disposed within the container and includes first and second ports, and a fluid outlet line is disposed about a wall of the container and includes first and second ports. The container includes at least one spacer for keeping the frozen substance a predetermined distance from the inside wall thereof.

### FIELD AND BACKGROUND OF THE INVENTION

The present invention is generally directed to thawing a frozen substance, and more particularly to a method and device for thawing a frozen substance, particularly food such as meat, fish, seafood, turkey, poultry, fruits, vegetables, bread, butter, or the like.

It is common to freeze edible and non-edible substances for transportation and to increase the shelf or effective life thereof. It is natural, therefore, and in many instances recommended or required, that the frozen substance be unfrozen or thawed prior to its use or consumption. Generally, the frozen substances are thawed by leaving it out in air, in open sinks, or subjecting them to microwave radiation. In this regard, various devices are available in prior art as illustrated in U.S. Patents/Patent Application Publication Nos. 4,062,277; 4,852,641; 5,146,843; 5,665,412; 6,260,580; 6,691,608; 6,874,938; 2005/0045047; 2006/0051477; 2009/0238939; and 2010/0281886; and Chinese Patent Document CN 201029421.

### ASPECTS OF THE INVENTION

The present disclosure is directed to various aspects of the present invention.

One aspect of the present invention includes a device for thawing a frozen food substance, such as meat, fish, seafood, turkey, poultry, fruit, vegetable, bread, butter, etc. The substance is defrosted rapidly and naturally without partial or any cooking, or waterlogging.

Another aspect of the present invention includes a device for thawing a frozen substance, such as edible or non-edible items, that results in uniform and consistent, and more natural thawing than, for example, in a microwave, which can create hot spots, partially cook food, and change food flavor, texture, and/or appearance.

Another aspect of the present invention includes a device for thawing a frozen substance that can be useful for quickly defrosting bulk-purchased food and meat, such as steaks and chops, chicken breasts, ground beef, ground turkey, seafood, etc., without the need for defrosting hours in advance.

Another aspect of the present invention includes a device for thawing a frozen substance, which keeps the frozen substance submerged in the water throughout the thawing process.

Another aspect of the present invention includes a device for thawing a frozen substance, which can be useful for marinating food, such as meats as they thaw. This would ensure a good contact between the marinade and the food item.

Another aspect of the present invention includes a device for thawing a frozen substance, which is simple in design and can utilize conventional/standard disposable freezer bags or shrink wrap bags, thereby making it more sanitary to operate and use, and easy to clean.

Another aspect of the present invention includes a device for thawing a frozen substance, the construction and design of which allows the fluid, such as water, to continuously flow through the device during thawing, using a kitchen faucet and requiring no faucet attachment.

Another aspect of the present invention includes a device for thawing a frozen substance, which produces zero or substantially no drip sound.

Another aspect of the present invention includes a device for thawing a frozen substance, the construction and design of which, specifically the intake funnel, regulates cycling of a fluid, such as water, through the device in a manner to ensure optimum defrosting time, while conserving water.

Another aspect of the present invention includes a device for thawing a frozen substance, including a container defining a recess for accommodating a frozen substance therein, a fluid inlet line disposed within the container and including first and second ports, a fluid outlet line disposed about a wall of the container and including first and second ports, wherein the container includes at least one spacer for keeping the frozen substance a predetermined distance from the inside wall thereof.

Another aspect of the present invention includes a device for thawing a frozen substance, including a container having top and bottom portions and defining a recess for accommodating a frozen substance therein, a fluid inlet line disposed within the container along one wall thereof and including first and second ports, a fluid outlet line disposed along another wall of the container and including third and fourth ports, wherein the first and third ports are disposed in the top portion of the container, and the second and fourth ports are disposed in the bottom portion thereof.

Another aspect of the present invention includes a device for thawing a frozen substance, including a container having a body portion and a cover. The body portion defines a recess for holding a bracket therein. The bracket includes first and second laterally spaced support members for securing a housing therebetween to accommodate a frozen substance therein. At least one spacer is provided on two opposed walls of the container for keeping the frozen substance a predetermined distance therefrom. A fluid inlet line is disposed within the container along one wall thereof, and a fluid outlet line is disposed within the container along another wall thereof. The cover includes a funnel-shaped fluid intake member in fluid communication with the fluid inlet line.

### BRIEF DESCRIPTION OF THE DRAWINGS

One of the above and other aspects, novel features and advantages of the present invention will become apparent from the following detailed description of a preferred embodiment(s) of the invention, as illustrated in the drawings, in which:

FIG. 1 is a perspective view of a device for thawing frozen substances in accordance with a preferred embodiment of the invention;

FIG. 2 is a partial exploded view of the device shown in FIG. 1;

FIG. 3 is an exploded view of the device shown in FIG. 1;

FIG. 4 is a sectional view taken along line 4-4 of FIG. 1; and

FIG. 5 is a sectional view taken along line 5-5 of FIG. 1.

### DETAILED DESCRIPTION OF THE PREFERRED EMBODIMENT(S) OF THE INVENTION

As best shown in FIGS. 1-3, a device for thawing a frozen substance TD, particularly a food item such as meat, fish, turkey, poultry, fruit, vegetable, bread, butter, etc., in accordance with a preferred embodiment of the invention, includes a container 10, preferably made of polyethylene or other suitable impermeable material. The container 10 includes a body portion 12 and a cover or lid 14.

The body portion 12 includes a top portion 16 and a bottom portion 18, and an opening 20 adjacent the top portion 16. The body portion 12 includes left and right generally opposed walls 22 and 24, respectively, and generally opposed front and rear walls 26 and 28, respectively. (It is noted herewith that although the container 10 is illustrated herein as having an oblong shape, it is within the scope of the invention to provide other shapes, such as square, rectangle, round, pentagon, hexagon, octagon, etc. It is also noted herewith that it is within the scope of the invention to provide the container 10 as one integral piece, instead of separate cover and body portion, as illustrated herein.)

The container 10 includes an internal recess 30 for receiving a bracket 32, which holds a frozen substance FS and a defrosting liquid, such as water W, as described below in more detail.

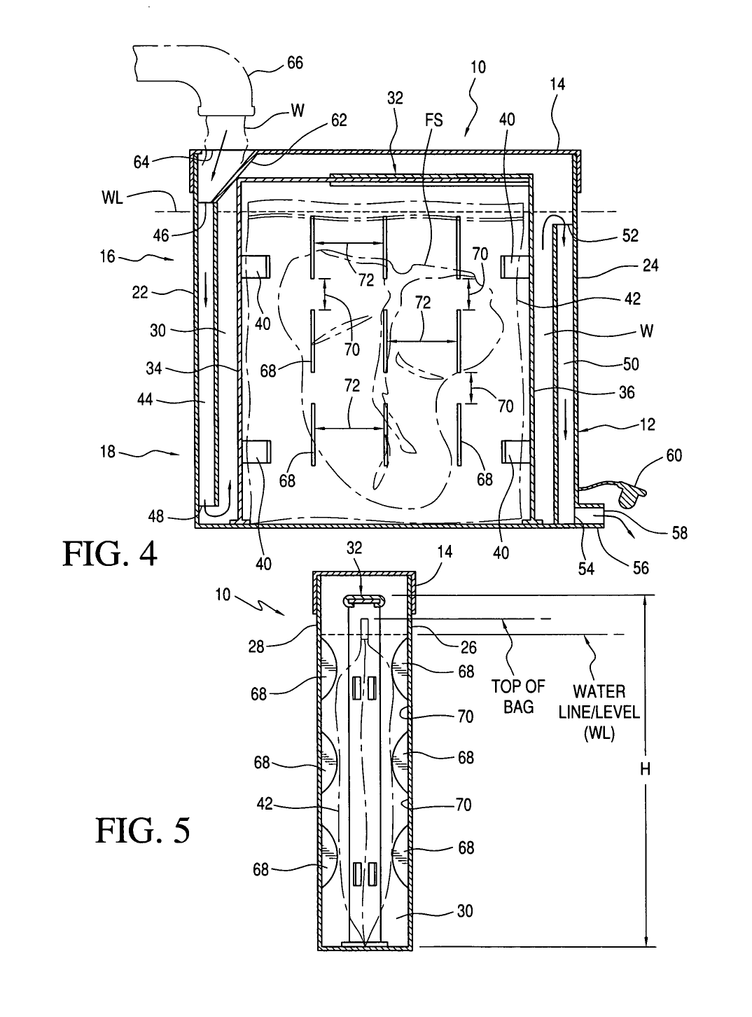

The bracket 32 is preferably an inverted U-shaped frame made of left and right L-shaped support members 34 and 36, respectively. The support members 34 and 36 are slidably connected to each other in a known manner to adjust the distance D therebetween. Preferably, each of the support members 34 and 36 includes a foot or base 38 to render it self-standing, or another means to stand the frame upright. Further, pinch-clips 40, or other suitable clips, are provided on the inside of the support members 34 and 36, such that a conventional plastic bag 42 is securely held therebetween (FIG. 4). The height H of the bracket 32 is selected in a manner that the top of bag 42 remains above a water line/level WL, to prevent the water from entering the bag, while the body of the bag 42, and thus the frozen substance FS, stay below the water line/level WL, and accordingly remain submerged in water W (FIG. 5).

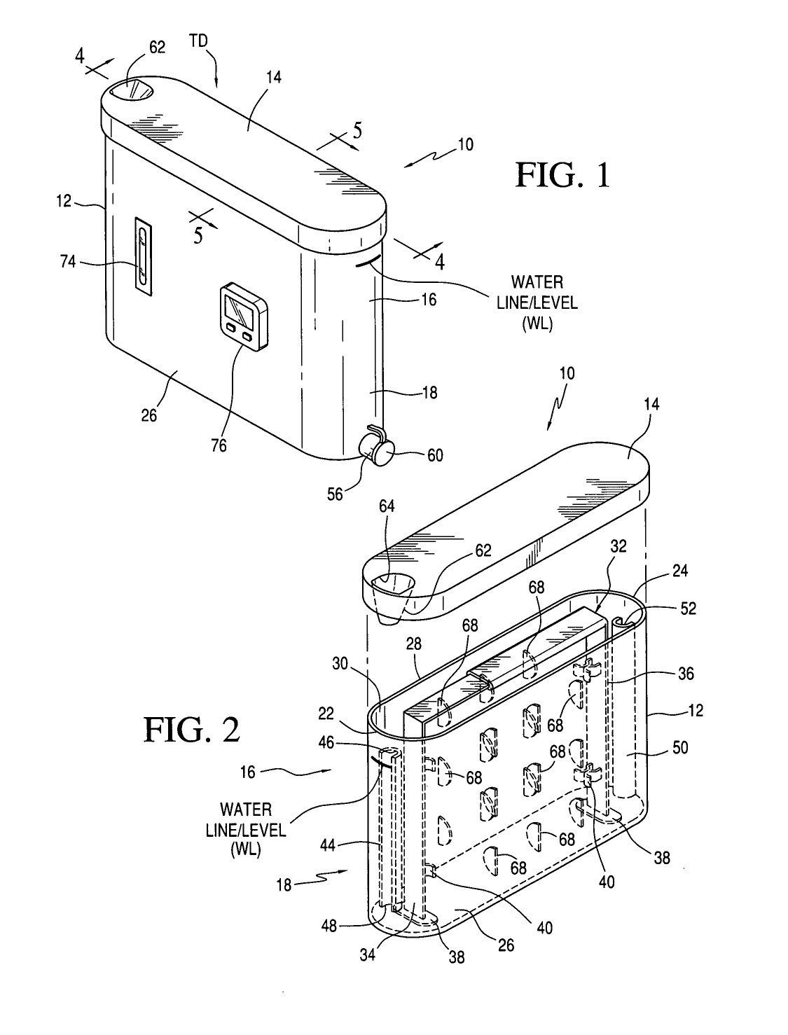

As best shown in FIGS. 2-4, a fluid inlet line 44 is disposed on the left wall 22 and includes inlet and outlet ports 46 and 48, respectively. Likewise, a fluid outlet line 50 is disposed on right wall 24 and includes fluid inlet and outlet ports 52 and 54, respectively. The outlet port 54 is in fluid communication with the exterior via a nipple 56, the opening 58 of which can be selectively opened or closed by a stopper 60 (FIG. 4).

As best shown in FIG. 4, the inlet port 46 of the fluid inlet line 44, is in fluid communication with preferably a funnel-shaped fluid intake member 62 having an opening 64 for receiving a fluid, such as water W, from a faucet or tap 66, or the like source. Preferably, the fluid-intake member 62 is incorporated in the cover 14, and its size/shape is selected so as to reduce any drip noise and/or cycle/flush the fluid or water W through the thawing device TD at a predetermined rate to comply with any applicable FDA regulations/guidelines, or as desired. In this regard, it is within the scope of the invention to choose other shapes or configurations for the fluid intake member 62.

As best illustrated in FIG. 4, the water W, entering the funnel-shaped member 62, would flow down into the fluid inlet line 44 and fill up the recess 30, by flowing out of the outlet port 48 disposed in the bottom portion 18 of the body portion 12. The recess 30 is filled-up up to a water line/level WL, which lies above the inlet port 52 of the fluid outlet line 50. In other words, the length or height of the fluid outlet line 50 is selected to be less than the height of the water line/level WL in the container 10. As a result, the fluid or water W in the recess 30 will flow out of or exit the container 10, by entering the inlet port 52, flowing through the fluid outlet line 50, and out of the thawing device TD through the nipple opening 58 via outlet port 54.

In summary, the height H of the bracket 32 is selected to be higher than the water line/level WL, to ensure that the top of the bag 42 remains above the water line/level WL, while the main body thereof (containing the frozen substance FS) remains submerged in the fluid or water W (FIG. 5). Likewise, the height of the water line WL in the container 10, is selected to be higher than the length or height of the fluid outlet line 50, such that the fluid or water W flows out of the container 10 via the inlet port 52 disposed in the top portion 16 thereof (FIG. 4). In the same manner, the height of the water line WL is selected to be lower than the length or height of the fluid inlet line 44, such that the fluid or water W flows into the container 10 via the outlet port 48.

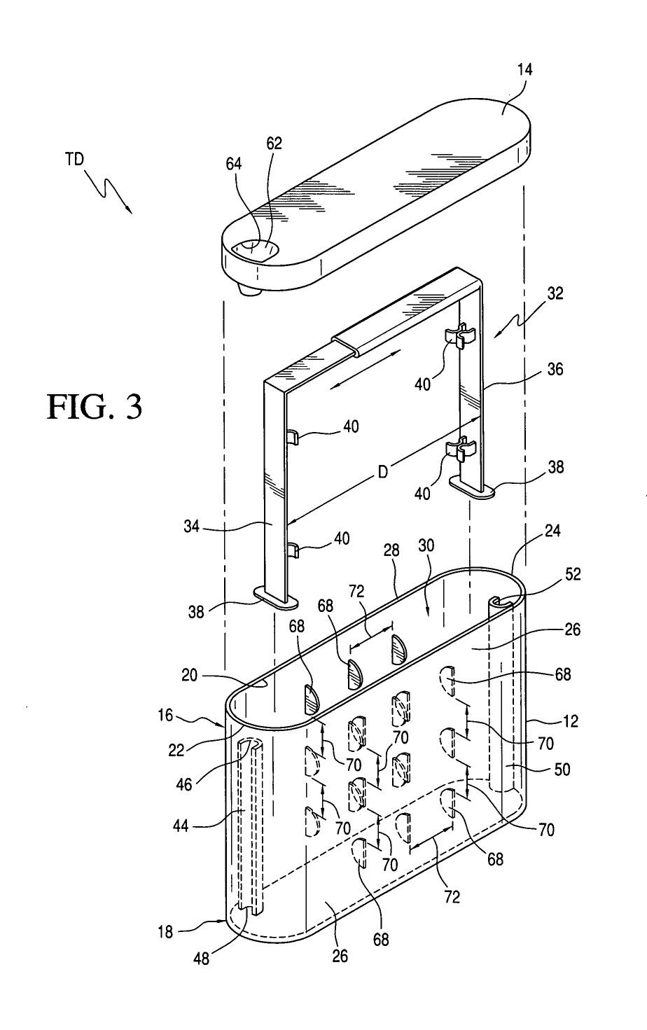

As best shown in FIGS. 3 and 5, the front and rear walls 26 and 28 of the body portion 12, are provided with inwardly projecting spacers 68, arranged vertically and separated by gaps 70 therebetween. The spacers 68 extend a predetermined distance into the recess 30, so as to prevent the bag 42 from becoming flat or compressed against the walls 26 and 28, thereby limiting fluid or water circulation around the frozen substance FS. In other words, the spacers 68 maintain the bag 42 a predetermined distance from the walls 26 and 28, thereby ensuring that the fluid or water W continues to flow through the gaps 70 and around the spacers 68. In this regard, it would be appreciated that the spacers 68 are separated from each other vertically by gaps 70, as well as horizontally by gaps 72. This ensures maximum contact between the bag 42 (and thus the frozen substance FS) and the fluid or water W, flowing through gaps 70 and 72.

Preferably, the spacers 68 are convex in shape, and extend about ½ to 1 inch into the recess 30 and are 1.5 to 3 inches in length. It is noted herewith that other shapes or configurations, and dimensions, may be utilized for the spacers 68. Likewise, spacers of different shapes and/or sizes may be used in homogeneous or heterogeneous patterns. In the same manner, identical spacers may be arranged in different arrays or patterns. The spacers may also be provided on the bottom of the container 10.

As best shown in FIG. 1, the thawing device TD is provided with a suitable thermometer 74 to show water temperature, and a timer 76 for the ease of the user to preselect a thawing time.

### Use and Operation

Referring to the figures, a preferred manner of using the thawing device TD of the present invention will now be described. A user removes the cover 14 and secures the bag 42 to the bracket 32. The bracket 32 is then inserted in the recess 30, and the frozen substance FS is placed inside the bag 42. The container is filled with a defrosting fluid or water W up to the water line WL, leaving the bag 42 open to allow the air to escape, while water is being added. The bag 42 is sealed and the cover 14 is replaced back over the opening 20. The thawing device TD is placed under the faucet 66 (or the like source) and the water W (preferably at room temperature) is allowed to enter the fluid-intake member 62 and flow through the device and around the bag 42 for a predetermined time, thereby defrosting the frozen substance FS. It is noted that the foregoing steps need not be followed in the same sequence.

It is noted herewith that while the invention has been described in terms of continuously running or flowing the water W around a frozen substance, a user may choose to thaw or defrost the frozen substance in non-running water by filling up the container with a defrosting fluid or water at a suitable/desirable temperature, as described above, and leaving the frozen substance therein for a desired time period.

While this invention has been described as having preferred sequences, ranges, steps, materials, structures, shapes, configurations, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

What is claimed is:

1. A device for thawing a frozen substance, comprising:
a) a container defining a recess for accommodating a frozen substance therein;
b) a fluid inlet line disposed within said container and including first and second ports;
c) a fluid outlet line disposed about a wall of said container and including first and second ports; and
d) said container including at least one spacer for keeping the frozen substance a predetermined distance from the inside wall thereof.

2. The device of claim 1, wherein:
a) a plurality of said spacers are disposed on the inside wall of said container.

3. The device of claim 1, wherein:
a) two of said spacers are disposed generally opposite to each other on the inside wall of said container.

4. The device of claim 1, wherein:
a) a plurality of said spacers comprise an array of alternating projections and gaps.

5. The device of claim 4, further comprising:
a) at least one of said projections is generally convex in shape.

6. The device of claim 1, wherein:
a) said container comprises a top portion and a bottom portion; and
b) said first port of said fluid inlet line is disposed in the top portion of said container and said second port of said fluid inlet line is disposed in the bottom portion thereof so as to fill said recess with a fluid from the bottom thereof.

7. The device of claim 6, wherein:
a) said first port of said fluid outlet line is disposed in the top portion of said container and is in fluid communication with said recess;
b) said second port of said fluid outlet line is in fluid communication with the exterior of the device; and
c) the fluid leaves said recess from the top portion of said container via said first port of said fluid outlet line and exits the device via said second port of said fluid outlet line.

8. The device of claim 6, wherein:
a) said fluid inlet line and said fluid outlet line are disposed generally opposite to each other.

9. The device of claim 6, wherein:
a) said container comprises a cover including a funnel-shaped fluid intake member with an opening for receiving the fluid; and
b) said fluid intake member is in fluid communication with said first port of said fluid inlet line.

10. The device of claim 1, further comprising:
a) a bracket for holding the frozen substance in said recess.

11. The device of claim 10, wherein:
a) said bracket comprises first and second laterally spaced support members; and
b) said first and second support members each includes a clip for securing a housing therebetween.

12. The device of claim 11, wherein:
a) said first and second members are adjustably connected to each other to vary the distance therebetween.

13. The device of claim 11, wherein:
a) said bracket secures a housing between said first and second support members; and
b) said housing for holding the frozen substance therein and keeping it immersed in a fluid during thawing.

14. The device of claim 13, wherein:
a) said bracket comprises an inverted U-shaped structure.

15. A device for thawing a frozen substance, comprising:
a) a container defining a recess for accommodating a frozen substance therein;
b) said container comprising a top portion and a bottom portion;
c) a fluid inlet line disposed within said container along one wall thereof and including first and second ports;
d) a fluid outlet line disposed along another wall of said container and including third and fourth ports; and
e) said first and third ports being disposed in the top portion of said container, and said second and fourth ports being disposed in the bottom portion thereof.

16. The device of claim 15, wherein:
a) said container includes a funnel-shaped fluid intake member comprising said first port.

17. The device of claim 15, wherein:
a) said second and third ports are in fluid communication with said recess; and
b) said first and fourth ports are in communication with the exterior of the device.

18. The device of claim 15, wherein:
a) said container includes a spacer on two opposed walls thereof for keeping the frozen substance a predetermined distance therefrom.

19. The device of claim 18, further comprising:
a) a bracket insertable in said recess for securing a housing; and
b) said housing for holding the frozen substance therein and keeping it immersed in a fluid during thawing.

20. A device for thawing a frozen substance, comprising:
a) a container comprising a body portion and a cover;
b) said body portion defining a recess for holding a bracket therein;
c) said bracket comprising first and second laterally spaced support members for securing a housing therebetween to accommodate a frozen substance therein;
d) at least one spacer on two opposed walls of said container for keeping the frozen substance a predetermined distance therefrom;
e) a fluid inlet line disposed within said container along one wall thereof;
f) a fluid outlet line disposed within said container along another wall thereof; and
g) said cover including a funnel-shaped fluid intake member in fluid communication with said fluid inlet line.

21. The device of claim 20, wherein:
a) said fluid inlet line includes first and second ports; and
b) said fluid outlet line includes third and fourth ports.

22. The device of claim 21, wherein:
a) said body portion includes a top portion and a bottom portion;
b) said second port is disposed in the bottom portion and is in fluid communication with said recess;
c) said third port is disposed in the top portion and is in fluid communication with said recess; and
d) said fourth port is in fluid communication with the exterior of the device.
